(19) United States
(12) Patent Application Publication
(10) Pub. No.: US 2004/0158780 A1
(43) Pub. Date: Aug. 12, 2004

(54) Method and system for presenting neighbors of a device in a network via a graphical user interface

(76) Inventor: Jeffrey Richard Conrad, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/361,588

(22) Filed: Feb. 11, 2003

(51) Int. Cl. G06F 11/00

(52) U.S. Cl. 714/100; 345/734

(57) ABSTRACT

A method and system are described for presenting neighbors of a device in a network via a graphical user interface. According to exemplary embodiments, a determination is made for a segment of the network that includes the device whether a connecting device is coupled to a corresponding connecting device included in another segment of the network. Identities of the device and the coupled connecting and corresponding connecting devices are presented together with visual cues identifying a connectivity among the presented identities in the graphical user interface.

### BACKGROUND

In many fields of process and performance management, operators face technical challenges as they work to identify the root cause of problems or events. The challenges can be difficult when tasked with managing large enterprise networks.

Network management products, such as Hewlett Packard's Network Node Manager (HP's NNM), aid network operators by providing fault management in which faults, or events, in a network are detected, isolated, and controlled. This can be carried out by network status monitoring, alarms, alerts, reporting, and predictive tools. Network management products can also provide performance management which measures the performance of network hardware, software, and media, such as throughput rate, percentage utilization, error rates, and response time, through the collection and analysis of data about the network. These products can also provide configuration and change management which includes the finding and setting up of the network devices that control the behavior of the network, and the centralized control of configurations.

Gathering the fault, performance, and configuration information from a large enterprise network is only a part of the overall network management task. Of equal, or perhaps greater, importance is the efficient and meaningful presentation of this information to a network operator so as to enable a proactive management of the network. Network management products use graphical network topology maps to present the information to operators.

Network topology maps have been organized into a hierarchical structure of submaps or views. A view can be presented in a high-level submap that represents the entire enterprise network, perhaps spanning the world, or can be presented in a more detailed submap representing any portion of the network. HP's NNM program product has a default map that includes four hierarchical submaps: an Internet-level submap (e.g., showing IP networks), a Network-level submap (e.g., showing bus, star, or ring segments), a Segment-level submap (e.g., showing hosts and routers), and a Node-level submap (e.g., showing network interface cards or NICs). Typically, a single submap is presented to an operator at any given time.

When determining the root cause of a network event or performance anomaly, it can be helpful for an operator to know the network devices physically located near a device triggering the event or alarm. By examining the operation of these neighboring devices, operators can better diagnose and resolve network problems, perhaps before a failure occurs. But, determining the neighbors of a device of interest can be difficult. For example, a connecting device, such as router, can exist in several Segment-level submap views. Each of these Segment-level views can include other connecting devices that can exist in several other Segment-level views, and so on. Traversing the various submaps to identify neighboring devices of a device of interest can be a time-consuming, difficult process that is prone to error as the number of submaps examined increases.

### SUMMARY

Accordingly, a method and system are described for presenting neighbors of a device in a network via a graphical user interface. According to exemplary embodiments, a determination is made for a segment of the network that includes the device whether a connecting device is coupled to a corresponding connecting device included in another segment of the network. Identities of the device and the coupled connecting and corresponding connecting devices are presented, together with visual cues identifying a connectivity among the presented identities in the graphical user interface.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a flowchart illustrating steps for presenting neighbors of a device in a network via a graphical user interface according to an exemplary embodiment;

FIG. 2 shows an arrangement for presenting neighbors of a device in a network via a graphical user interface according to an exemplary embodiment; and

FIG. 3 depicts visual cues for identifying a connectivity among identities of neighboring devices presented in a graphical user interface.

### DETAILED DESCRIPTION

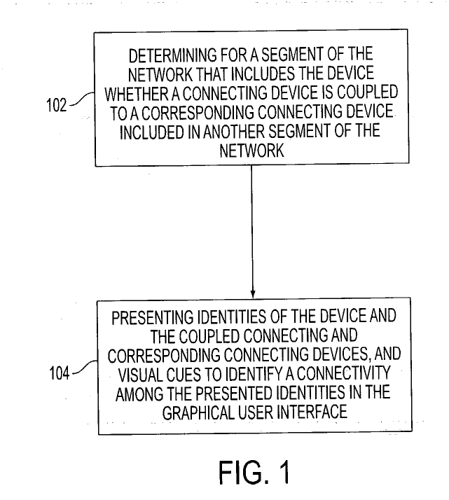

FIG. 1 is a flowchart illustrating the steps for presenting neighbors of a device in a network via a graphical user interface (GUI) according to an exemplary embodiment. In step 102, a determination is made for a segment of the network that includes the device whether a connecting device is coupled to a corresponding connecting device included in another segment of the network. As used herein, a segment can be a part of a network (e.g., an Ethernet network), on which all message traffic is common to all nodes. In other words, a segment can be a part of the network in which the message traffic can be broadcast from one node on the segment, and can be received by all other nodes operating on the segment.

A segment can include a single continuous conductor upon which the common message traffic is broadcast. A segment can also include simple repeaters and hubs that enhance the data signals carried long distances over the segment. Since all nodes in a segment share a physical medium, collision detection or some other protocol is required to determine whether a message was transmitted without interference from other nodes. The receiving node inspects the destination address of a packet to tell if it was (one of) the intended recipient(s). Communication between nodes on different segments can be achieved via one or more routers.

As used herein, a connecting device can be any device that connects respective network segments together. Connective devices can include bridges, switches, routers, and gateways. Repeaters and hubs can also be connecting devices when a segment is considered to include only a single continuous conductor upon which the common message traffic is broadcast.

NNM and other network management products can initially perform a discovery process that automatically discovers each device on a network and its connective relationship among other network devices. Information describing the connective relationships uncovered during the discovery process can be stored in one or more databases. This information can include an identity (e.g., a hostname and/or IP address) of a device and a relative location of a device in the network (e.g., a network ID, a segment ID, etc.). For example, NNM stores connectivity information in both object and topology databases that are used to form an initial network topology map and to set up a system for tracking network events, respectively. These databases can include information describing whether a particular device is a connecting device (e.g., a bridge, switch, router, etc.) or a non-connecting device (e.g., a NIC).

Information stored in such databases can be mined to determine whether a connecting device, included in the segment including the device, is coupled to a corresponding connecting device included in another segment of the network. The connecting device can be directly connected to the corresponding connecting device or can be indirectly coupled to the corresponding connecting device via one or more intermediary corresponding connecting devices. In either case, the corresponding connecting device is included in a different segment of the network than the segment that includes the device of interest.

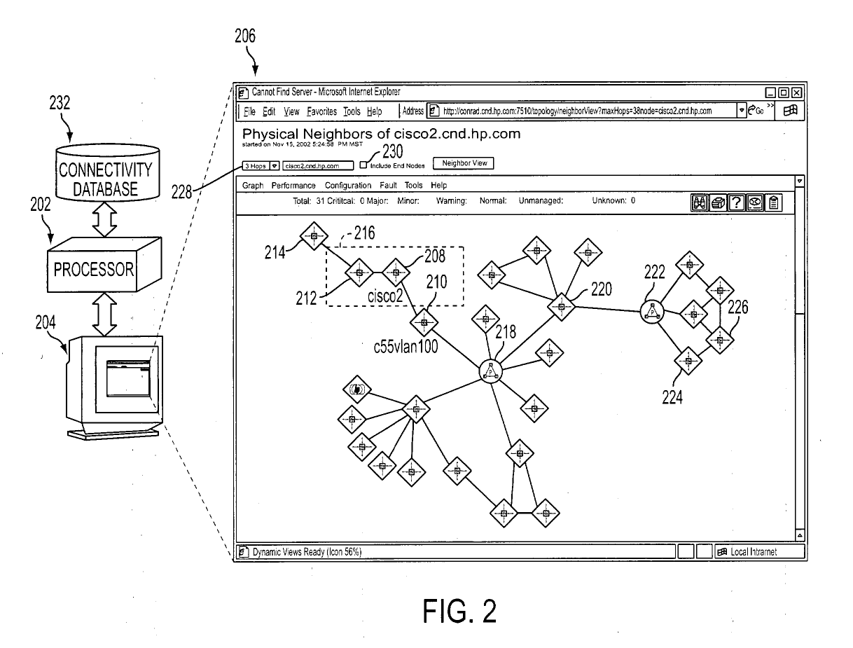

When it is determined that a connecting device, included in the segment including the device of interest, is coupled to a corresponding connecting device included in another segment of the network, identities of the device and the coupled connecting and corresponding connecting devices are presented in the GUI in step 104. The identities can be the respective hostnames or IP addresses of the devices, or any other unique identifiers. It will be understood that the device itself can be the connecting device coupled to the corresponding connecting device, in which case identities of the device/connecting device and the corresponding connecting device will be presented in the GUI. For example, in the GUI 206 shown in FIG. 2, the device of interest 208, also a connecting device identified as “cisco2”, is presented in the GUI 206 together with a corresponding connecting device 210, identified as “c55vlan100”. The connecting device 208 is included in a first segment of the network and the corresponding connecting device is included in another segment of the network.

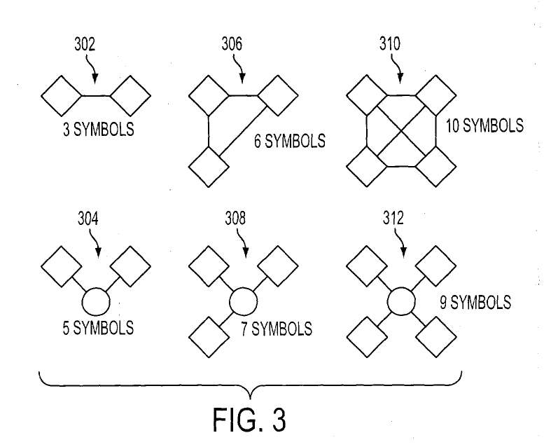

Also in step 104, visual cues are presented in the GUI to identify a connectivity among the presented identities. As used herein, visual cues can include any visual attribute of the GUI that can be used to signify a connectivity relationship among the presented device identities. An exemplary list of visual attributes includes lines and/or symbols, coloring (foreground and background), unique relative positioning (e.g., among device identities belonging to a common network segment), shading, graphics (e.g., 3D, dashed or solid lines), and text attributes (e.g., identifying common network portions, segments, etc.). In addition, different types of visual cues can be combined to show added connectivity relationships among the presented devices, as discussed in greater detail below in conjunction with FIG. 3. It will be understood that the exemplary list of visual cues provided is not exhaustive.

According to exemplary embodiments, the steps of determining whether a connecting device is coupled to a corresponding connecting device and then presenting identities of the coupled connecting devices can be repeated until the identities of all connecting devices included in the segment and the identities of all corresponding connecting devices coupled to the connecting devices included in the segment are presented in the graphical user interface.

For example, in FIG. 2, the device 212 can be the second of two connecting devices (e.g., devices 208 and 212) included in the segment 216 that includes the device of interest 208. The segment 216 is indicated, for illustration purposes only, by the dashed box. The connecting device 212 can in turn be coupled to another connecting device 214 in yet another segment of the network. The steps of determining and presenting can be repeated until all the identities of all connecting devices in the segment 216 (two in this example, e.g., devices 208 and 212) and all corresponding connecting devices in other segments of the network, e.g., devices 210 and 216 are presented in the GUI 206.

The repeating of the steps of determining whether a connecting device is coupled to a corresponding connecting device and then presenting identities of the coupled connecting devices can be carried our recursively to form an extensive neighbor view. The steps can be repeated recursively for each segment of the network that includes a corresponding connecting device coupled to the connecting devices included in the same segment as the device of interest.

For example, in the arrangement depicted in FIG. 2, the corresponding connecting device 210 is coupled to the device of interest 208 (a connecting device itself) in the first segment 216. The corresponding connecting device 210 is included in a second segment indicated by a segment symbol 218. Recursively repeating the steps of determining and presenting for all connecting devices in the second segment 218 can determine that the segment 218 includes a corresponding connecting device 220 that is coupled to a corresponding connecting device 224 included in a third segment of the network. The third segment of the network is indicated by a segment symbol 222.

The process can then be recursively repeated for all connecting devices in the third segment 222 until identities of all corresponding connecting devices coupled (directly or indirectly) to the device of interest 208 a predetermined number of segments away from the first segment 216 are presented in the GUI 206. The number of segments (or hops) away from the first segment 216 for which the steps of determining and presenting are to be recursively repeated can be specified via a control 228 provided in the GUI 206.

In the example shown in FIG. 2, the number of hops is specified to be three. The first hop is from the first segment 216, including the device of interest 208, to the second segment 218 including the corresponding connecting device 210. Since the corresponding connecting device 220 is also in the second segment 218, it is also one hop away from the device 208. The second hop in the example is from the corresponding connecting device 220, included in the second segment 218, to the device 224 included the third segment 222. A third and final hop is from the device 224 to another connecting device 226 included in a fourth segment of the network (in the exemplary FIG. 2 illustration, the fourth segment is represented as the connecting device 226).

FIG. 3 depicts visual cues for identifying a connectivity among identities of neighboring devices presented in a graphical user interface. According to exemplary embodiments, when the identities of only two connecting devices in a same segment of the network are presented in the GUI, the visual cues include one line extending between the two connecting devices. For example, a first arrangement 302 shown in FIG. 3 includes three symbols, two diamond-shaped connecting device symbols and one line connecting the symbols. Note that this arrangement presents the two-device connection with more efficiency (i.e., with less symbols) than a second five-symbol arrangement 304 that includes a circular-shaped connector symbol. Accordingly, the first arrangement 302 can be used over the second arrangement 304 when two connecting devices in a same segment of the network are presented in the GUI.

When the identities of three connecting devices in a same segment of the network are presented in the graphical user interface, the visual cues can include three lines extending between each of the three connecting devices. For example, a third arrangement 306 shown in FIG. 3 includes six symbols, three diamond-shaped connecting device symbols and three lines connecting each of the symbols. Note again that the third arrangement 306 presents the three-device connection more efficiently than a fourth seven-symbol arrangement 308 that includes a circular-shaped connector symbol. Accordingly, the third arrangement 306 can be used over the fourth arrangement 308 when three connecting devices in a same segment of the network are presented in the GUI.

When the identities of four or more connecting devices in a same segment of the network are presented in the graphical user interface, the visual cues can include a connector symbol and one line extending between each of the four or more connecting devices and the connector symbol. For example, a fifth arrangement 310 shown in FIG. 3 includes ten symbols, four diamond-shaped connecting device symbols and six lines connecting each of the symbols. A sixth nine-symbol arrangement 312 that includes a circular-shaped connector symbol presents the four-device connection more efficiently than fifth arrangement 310.

When four or more connecting devices are included in a same segment, arrangements including a connecting symbol can be presented in the GUI more efficiently than arrangements that do not. As the number of connecting devices increases linearly, the number of symbols needed to present their connectivity increases exponentially. For example, an arrangement with five connecting devices and no connector symbol can use fifteen symbols, but an arrangement with five nodes and a connector symbol uses eleven symbols. For six connecting devices, the number of symbols can be reduced from twenty-one to thirteen by using a connector symbol.

According to exemplary embodiments, identities of all devices included in the segment of the network that includes the device can be presented irrespective of whether the devices are coupled to a corresponding connecting device included in another segment of the network. Such devices can be referred to as “end devices”, as the devices represent the end of a connection chain. Including the identities of end nodes will add the identities all network devices a specified number of hops from the device of interest to the presentation. This can add significant clutter to the presentation, but can be helpful in the latter stages of problem resolution and fault identification.

Various aspects will now be described in connection with exemplary embodiments. To facilitate an understanding of these embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs a described action or as “logic capable of” performing the action.

A system for presenting neighbors of a device in a network via a GUI according to an exemplary embodiment is shown in FIG. 2. The system includes a processor 202 and a display 204. The processor 202 includes logic capable of determining for a segment of the network that includes the device whether a connecting device is coupled to a corresponding connecting device included in another segment of the network. The processor 202 can mine information stored in a connectivity database 232 to determined whether a connecting device, included in the segment including the device, is coupled to a corresponding connecting device included in another segment of the network. The terms “segment”, “connecting device”, and “coupled” have meanings consistent with those described in conjunction with the exemplary method illustrated in FIG. 1.

The processor 202 further includes logic capable of presenting identities of the device and the coupled connecting and corresponding connecting devices, and visual cues to identify a connectivity among the presented identities in the GUI. The GUI including the identities and visual cues can be displayed on the display 204. The term “visual cues” has a meaning consistent with that described in conjunction with the exemplary method illustrated in FIG. 1.

In addition to including logic capable of performing the various tasks described above, the system can also include a GUI having a first control capable of providing an input of the predetermined number of segments (or hops) away from the segment that includes the device. An exemplary multi-selection list box 228 is illustrated in FIG. 2. The GUI can also include a second control capable of providing an input to determine if identities of all devices included in the segment of the network that includes the device are presented in the GUI, irrespective of whether the devices are coupled to a corresponding connecting device or whether the devices are “end nodes”. An exemplary check box 230 is illustrated in FIG. 2.

The steps of a computer program as illustrated in FIG. 1 for presenting neighbors of a device in a network via a graphical user interface can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

The computer program performs the steps of determining for a segment of the network that includes the device whether a connecting device is coupled to a corresponding connecting device included in another segment of the network, and presenting identities of the device and the coupled connecting and corresponding connecting devices, and visual cues to identify a connectivity among the presented identities in the graphical user interface.

The computer program can also perform the step of repeating the determining and presenting until the identities of all connecting devices included in the segment and the identities of all corresponding connecting devices coupled to the connecting devices included in the segment are presented in the graphical user interface. In addition, the computer program can perform the step of recursively repeating the determining and presenting for each segment of the network that includes a corresponding connecting device coupled to the connecting devices included in the segment until all connecting devices a predetermined number of segments away from the segment that includes the device are presented in the graphical user interface.

Repeating the determining and presenting for each segment of the network that includes a corresponding connecting device recursively can be accomplished via a computer programming procedure, subroutine, function, or algorithm that calls itself in a step having a termination condition so that successive repetitions are processed up to the step until the condition is met, at which time the rest of each repetition is processed from the last one called to the first. The following exemplary pseudo-code illustrates a recursive process in which the procedure “findNeighborsOfNode” calls itself successive repetitions until a condition “numHops<maxhops” is met.

```
maxHops = <User Defined>
StartingNode = <User defined>
addNodeToDisplayList (StartingNode);
findNeighborsOfNode (StartingNode, 0, maxHops);
computeConnectivityForDisplayListFromStoredTopology( );
displayNodesInDisplayList( );
// Routine to find neighbors of node
findNeighborsOfNode (Node, numHops, maxHops) {
    segmentNodeList = findNodesInSegment (Node)
    while (thisNode in segmentNodeList) {
        if (thisNode != connector) {
            if (UserWantsEndNodes) {
                addNodeToDisplay (thisNode);
            }
```

| | |
|---|---|
| next; // | do not need to recursively find nodes; |
| | node is not a connector and has no |
| | other neighbors |

```
        }
        addNodeToDisplayList (thisNode)
        if (numHops < maxHops) {
```

| | |
|---|---|
| // | keep expanding search by recursively |
| | calling this procedure |

```
            findNeighborsOfNode (thisNode, numHops+1, maxHops);
        }
    }
}
```

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for presenting neighbors of a device in a network via a graphical user interface, the method comprising:
determining for a segment of the network that includes the device whether a connecting device is coupled to a corresponding connecting device included in another segment of the network; and
presenting identities of the device and the coupled connecting and corresponding connecting devices, and visual cues to identify a connectivity among the presented identities in the graphical user interface.

2. The method of claim 1, comprising:
repeating the determining and presenting until the identities of all connecting devices included in the segment and the identities of all corresponding connecting devices coupled to the connecting devices included in the segment are presented in the graphical user interface.

3. The method of claim 2, comprising:
recursively repeating the determining and presenting for each segment of the network that includes a corresponding connecting device coupled to the connecting devices included in the segment until all connecting devices a predetermined number of segments away from the segment that includes the device are presented in the graphical user interface.

4. The method of claim 3, wherein when the identities of only two connecting devices in a same segment of the network are presented in the graphical user interface, the visual cues include one line extending between the two connecting devices.

5. The method of claim 3, wherein when the identities of only three connecting devices in a same segment of the network are presented in the graphical user interface, the visual cues include three lines extending between each of the three connecting devices.

6. The method of claim 3, wherein when the identities of four or more connecting devices in a same segment of the network are presented in the graphical user interface, the visual cues include a connector symbol and one line extending between each of the four or more connecting devices and the connector symbol.

7. The method of claim 1, comprising:
presenting identities of all devices included in the segment of the network that includes the device irrespective of whether the devices are coupled to a corresponding connecting device included in another segment of the network.

8. A system for presenting neighbors of a device in a network via a graphical user interface, the system comprising:
a processor including:
logic capable of determining for a segment of the network that includes the device whether a connecting device is coupled to a corresponding connecting device included in another segment of the network; and
logic capable of presenting identities of the device and the coupled connecting and corresponding connecting devices, and visual cues to identify a connectivity among the presented identities in the graphical user interface; and
a display for displaying the graphical user interface including the presented identities and visual cues.

9. The system of claim 8, wherein the processor comprises:
logic capable of repeating the determining and presenting until the identities of all connecting devices included in the segment and the identities of all corresponding connecting devices coupled to the connecting devices included in the segment are presented in the graphical user interface.

10. The system of claim 9, wherein the processor comprises:
logic capable of recursively repeating the determining and presenting for each segment of the network that includes a corresponding connecting device coupled to the connecting devices included in the segment until all connecting devices a predetermined number of segments away from the segment that includes the device are presented in the graphical user interface.

11. The system of claim 10, wherein the graphical user interface comprises a control capable of providing an input of the predetermined number of segments away from the segment that includes the device.

12. The system of claim 10, wherein when the identities of only two connecting devices in a same segment of the network are presented in the graphical user interface, the visual cues include one line extending between the two connecting devices.

13. The system of claim 10, wherein when the identities of only three connecting devices in a same segment of the network are presented in the graphical user interface, the visual cues include three lines extending between each of the three connecting devices.

14. The system of claim 10, wherein when the identities of four or more connecting devices in a same segment of the network are presented in the graphical user interface, the visual cues include a connector symbol and one line extending between each of the four or more connecting devices and the connector symbol.

15. The system of claim 8, wherein the processor comprises:
logic capable of presenting identities of all devices included in the segment of the network that includes the device irrespective of whether the devices are coupled to a corresponding connecting device included in another segment of the network.

16. The system of claim 15, wherein the graphical user interface comprises a control capable of providing an input to determine if identities of all devices included in the segment of the network that includes the device irrespective of whether the devices are coupled to a corresponding connecting device included in another segment of the network are presented in the graphical user interface.

17. A computer readable medium containing a computer program for presenting neighbors of a device in a network via a graphical user interface, wherein the computer program performs the steps of:
determining for a segment of the network that includes the device whether a connecting device is coupled to a corresponding connecting device included in another segment of the network; and
presenting identities of the device and the coupled connecting and corresponding connecting devices, and visual cues to identify a connectivity among the presented identities in the graphical user interface.

18. The computer readable medium of claim 17, wherein the computer program performs the step of:
repeating the determining and presenting until the identities of all connecting devices included in the segment and the identities of all corresponding connecting devices coupled to the connecting devices included in the segment are presented in the graphical user interface.

19. The computer readable medium of claim 17, wherein the computer program performs the step of:
recursively repeating the determining and presenting for each segment of the network that includes a corresponding connecting device coupled to the connecting devices included in the segment until-all connecting devices a predetermined number of segments away from the segment that includes the device are presented in the graphical user interface

20. The computer readable medium of claim 17, wherein the computer program performs the step of:
presenting identities of all devices included in the segment of the network that includes the device irrespective of whether the devices are coupled to a corresponding connecting device included in another segment of the network.
